(19) United States
(12) Patent Application Publication
(10) Pub. No.: US 2009/0054547 A1
(43) Pub. Date: Feb. 26, 2009

(54) METHOD FOR THE PREPARATION OF A TRANSPARENT MOULDING BASED ON A BLEND OF THERMOPLASTIC POLYMER AND THERMOSETTING POLYMER

(75) Inventors: Fabien Berit-Debat, Charenton Le Pont (FR); Noemie Lesartre, Charenton Le Pont (FR)

Correspondence Address: OCCHIUTI ROHLICEK & TSAO, LLP, 10 FAWCETT STREET, CAMBRIDGE, MA, 02138, US

(73) Assignee: Essilor International (Compagnie Generale D'Optique), Charenton Le Pont (FR)

(21) Appl. No.: 12/197,626

(22) Filed: Aug. 25, 2008

Related U.S. Application Data
(60) Provisional application No. 60/957,714, filed on Aug. 24, 2007.
(60) Provisional application No. 60/974,084, filed on Sep. 21, 2007.
(60) Provisional application No. 60/977,379, filed on Oct. 4, 2007.
(60) Provisional application No. 61/044,504, filed on Apr. 13, 2008.
(60) Provisional application No. 61/076,686, filed on Jun. 29, 2008.

(30) Foreign Application Priority Data
Aug. 29, 2007 (FR) 0706055

(51) Int. Cl. G02B 1/04; B29D 11/00; B29C 35/16

(52) U.S. Cl. 523/106; 264/1.32; 264/28

(57) ABSTRACT

The present invention relates to a method of preparing a transparent moulding comprising a blend of a first thermoset polymeric material forming the matrix of said moulding, and of a second polymeric material dispersed within said first material, said method comprising at least the following stages:
i) preparation of a liquid polymerizable mixture by dissolving said second polymeric material in a thermosetting polymerizable composition that is a precursor of said first thermoset polymeric material,
ii) filling of a mould with the liquid polymerizable mixture obtained in stage i),
iii) cooling of the liquid polymerizable mixture in the mould to a temperature T less than or equal to 0° C.,
iv) initiation of the polymerization of said cooled liquid polymerizable mixture at a temperature T′ less than or equal to 0° C.,
v) continuation of the polymerization of said liquid polymerizable mixture until a hardened blend of polymers is obtained, and
vi) removal of the moulding formed from said blend of polymers from the mould.
   The invention also relates to a transparent moulding obtainable by such a method comprising a blend of polymers, at least one of which is a thermosetting polymer.

The present invention relates to a method of cast moulding allowing a transparent article to be obtained, non- or very little diffusing, formed from a blend of a thermoset polymeric material and a polymeric material that modifies the mechanical and/or optical properties of the thermoset polymeric material, in particular a thermoplastic polymeric material, the thermoset polymeric material generally constituting the main phase of the blend. The method employs a stage of polymerization and crosslinking of a thermosetting composition, in particular by photopolymerization, the conditions of which have been optimized in order to avoid macro-phase separation. The invention relates more particularly to the field of ophthalmic lenses.

There are two types of substrates generally used for the manufacture of optical articles, for example ophthalmic lenses, namely substrates of mineral glass and substrates of organic glass. Currently, the market is tending to develop very largely in favour of organic glasses, which have two major advantages over mineral glasses: their good impact resistance and their lightness. The most-used organic glass substrates are bisphenol A polycarbonate and that obtained by polymerization of diethylene glycol bis(allyl carbonate), sold under the trade name CR 39® by the company PPG INDUSTRIES (ORMA® ESSILOR lens). Other allyl carbonates of linear or branched, aliphatic or aromatic polyols can be used. There may also be mentioned the organic glasses obtained by polymerization of thio(meth)acrylic monomers, of thio-urethane monomers, of C₁-C₄ alkyl(meth)acrylate monomers, such as methyl methacrylate, of polyethoxylated aromatic poly(meth)acrylate monomers such as ethoxylated bisphenol A di(meth)acrylates, in particular 2,2-bis[4-(methacryloxy-diethoxy)-phenyl]-propane.

Although the known organic substrates are generally satisfactory, it would be desirable to have available other types of polymerizable compositions allowing novel transparent substrates to be obtained, leading to optical articles combining useful properties such as good resistance to impact and to solvents. Certain substrates based on blends of polymers allow these objectives to be achieved.

A blend of polymers, in the sense in which this term is used in the present invention, denotes a mixture of at least two polymers of different chemical nature. There are three broad categories of blends of polymers: (1) a blend of one thermosetting polymer with another thermosetting polymer; (2) a blend of one thermoplastic polymer with another thermoplastic polymer; and (3) a blend of a thermoplastic polymer with a thermosetting polymer. However, there is a limited range of blends of polymers that are transparent and non- or very little diffusing, especially in the case of blends of the thermoplastic/thermoset type.

The aim of the present invention is to provide a method of cast moulding allowing an article to be obtained consisting of a blend of polymers comprising a first thermoset polymeric material and a second polymeric material, preferably thermoplastic, modifying the mechanical and/or optical properties of the thermoset polymeric material, while avoiding a macro-phase separation, which is the cause of clouding of the material obtained, so that the moulding obtained is transparent and non- or very little diffusing.

By transparent, non-diffusing or very little diffusing article or material is meant, within the meaning of the present invention, that observation of an image through the article is perceived without significant loss of contrast. In other words, the interposing of the transparent article between an image and an observer of the latter does not significantly reduce the quality of the image.

The subject-matter of the present invention is accordingly a method for the preparation of a transparent moulding comprising a blend of a first thermoset polymeric material constituting the matrix of said moulding, and of a second polymeric material, preferably a thermoplastic polymeric material, dispersed within said first thermoset polymeric material, said method comprising at least the following stages:

i) preparation of a liquid polymerizable mixture by solubilizing said second polymeric material in a thermosetting polymeric composition that is a precursor of said first thermoset polymeric material,

ii) filling of a mould with the liquid polymerizable mixture obtained in stage i),

iii) cooling of the liquid polymerizable liquid mixture in the mould to a temperature T less than or equal to 0° C.,

iv) initiation of the polymerization of said cooled liquid polymerizable mixture at a temperature T′ less than or equal to 0° C.,

v) continuation of the polymerization of said liquid polymerizable mixture until a hardened blend of polymers is obtained, and

vi) removal of the moulding formed from said blend of polymers from the mould.

Another subject-matter of the present is a transparent moulding that can be obtained by said method, said moulding comprising a blend of polymers, at least one of which is a thermosetting polymer.

The transparent moulding produced by the method of the invention is constituted by a blend of polymers. It comprises a first thermoset polymeric material forming the matrix of the finished article and, dispersed within said first hardened polymeric material, a second polymeric material, preferably of a thermoplastic nature, capable of modifying the mechanical and/or optical properties of said first polymeric material.

The thermoset phase formed by the first material is preferably the main phase. The first thermoset polymeric material can in principle comprise one or more crosslinked polymers, but preferably contains a single crosslinked polymer.

Likewise, the second polymeric material can comprise one or more polymers, but preferably comprises a single thermoplastic polymer.

The transparent moulding is produced, according to the invention, by polymerization of a liquid polymerizable mixture, comprising a thermosetting polymerizable composition (precursor of the thermoset polymer) in which said second polymeric material is solubilized, the hardening of said thermosetting polymerizable composition forming the first thermoset material. The second material must consequently be soluble in said thermosetting polymerizable composition of the liquid polymerizable liquid.

The method of the invention is characterized in that, at the end of the mould filling stage, the temperature of the liquid polymerizable mixture is set at a temperature T less than or equal to 0° C., and in that the initiation and optionally the continuation of the polymerization of said liquid polymerizable mixture is carried out at a temperature T′ less than or equal to 0° C., where T′ can be identical to or different from T. These particular polymerization conditions make it possible to avoid the phenomenon of macro-phase separation between the first polymeric material during polymerization and the thermoplastic polymer dispersed in the first material. Effectively, the cooling of the polymerizable mixture to a temperature less than or equal to 0° C. increases its viscosity and prevents the expulsion of the phase constituted by the second material from the growing thermoset network constituting the first material. The chemical gel state of the thermoset material is thus reached before any notable macro-phase separation can occur.

Preferably, the value of the cooling temperature T of the composition and the value of the temperature T′ at which the polymerization of the polymerizable liquid mixture is initiated is, independently, between −15° C. and 0° C., even better between −12° C. and −5° C. The temperature T′ can vary during initiation and polymerization, but must remain within the specified range.

The adjective “thermosetting” or “thermoset” as used in the present application does not denote a system or a composition that is hardenable or hardened by application of heat. In fact, it follows from the foregoing that the hardening by polymerization and crosslinking takes place, on the contrary, at a temperature less than or equal to 0° C., i.e. after cooling of the composition. This term is used in the present application, as in the field of plastics in general, as the opposite of the term “thermoplastic”. In other words, a thermoset polymer is a hard material, formed by a highly crosslinked three-dimensional macromolecular network that does not become fluid at elevated temperature.

The thermosetting polymerizable composition preferably represents from 70 to 97% of the mass of the polymerizable liquid mixture. It comprises at least one polymerizable material selected from a polymerizable monomer, a polymerizable oligomer and a polymerizable prepolymer.

The thermosetting polymerizable composition of the invention preferably comprises at least one monomer selected from a polymerizable aliphatic polymethacrylate monomer, a polymerizable aromatic polymethacrylate monomer, a polymerizable aliphatic polyacrylate monomer, and a polymerizable aromatic polyacrylate monomer.

The aliphatic poly(meth)acrylates that can be used in the present invention include any aliphatic compound containing, in its structure, at least two (meth)acrylate functions, such as aliphatic di-, tri-, tetra-, penta- or hexa(meth)acrylate compounds. The aliphatic group of the aliphatic poly(meth)acrylates of the invention can be, without limitation, a linear or branched C₁-C₁₀ aliphatic group, which can contain one or more double bonds, a C₁-C₂₅ polyalkylene glycol, alkoxyalkylene or hydroxyalkylene group. Generally, the aliphatic poly(meth)acrylates that can be used in the present invention can be all the compounds obtained by reaction of a bifunctional or polyfunctional aliphatic alcohol with acrylic acid or methacrylic acid, said bifunctional or polyfunctional aliphatic alcohol being able to be modified as desired by a carboxylic acid or by ethylene oxide or propylene oxide. Particular non-limiting examples of aliphatic poly(meth)acrylates are ethylene di(meth)acrylate, propylene di(meth)acrylate, trimethylene di(meth)acrylate, tetramethylene di(meth)acrylate, hexamethylene di(meth)acrylate, decamethylene di(meth)acrylate, glycerol tri(meth)acrylate, diethylene glycol di(meth)acrylate, triethylene glycol di(meth)acrylate, tetraethylene glycol di(meth)acrylate, pentaerythritol tri(meth)acrylate, pentaerythritol tetra(meth)acrylate, dimethylolpropane tri(methacrylate) modified by hydroxypivalylaldehyde, trimethylolethane tri(meth)acrylate, trimethylolpropane tri(meth)acrylate, ditrimethylolpropane tetra(meth)acrylate, dipentaerythritol tri(meth)acrylate, dipentaerythritol tri(meth)acrylate modified by propionic acid, dipentaerythritol tetra(meth)acrylate, dipentaerythritol penta(meth)acrylate, dipentaerythritol hexa(meth)acrylate, tripentaerythritol hexa(meth)acrylate, tripentaerythritol hepta(meth)acrylate, tripentaerythritol octa(meth)acrylate and mixtures thereof.

The aromatic poly(meth)acrylates that can be used in the present invention include all the aromatic compounds containing, in their structure, at least two (meth)acrylate functions, such as aromatic di-, tri-, tetra-, penta- or hexa(meth)acrylate compounds. Preferably, the aromatic poly(meth)acrylates are selected from the aromatic di(meth)acrylates, even better, from the polyalkoxylated aromatic dimethacrylates and the polyalkoxylated aromatic diacrylates.

A preferred class of polyalkoxylated aromatic di(meth)acrylates comprises the compounds conforming to formula (i):

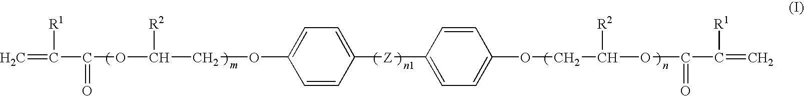

in which R¹ represents a hydrogen atom or a C₁-C₆ alkyl radical, R² represents a hydrogen atom, a C₁-C₆ alkyl radical or the 2-hydroxyethyl group, n1 is equal to 0 or 1, the sum m+n being an integer in the range from 1 to 10.

When n1 is equal to 1, Z denotes O, S, Se, NH, C═O, SO, SO₂, SeO₂, CH₂, —CH═CH— or —C(R)₂— with R representing a hydrogen atom or a C₁-C₆ alkyl radical. In accordance with the invention, R¹ and R² each denote, independently of one another, preferably a methyl group, ethyl group or a hydrogen atom. The more particularly preferred compounds of formula (I) conform to formula (II):

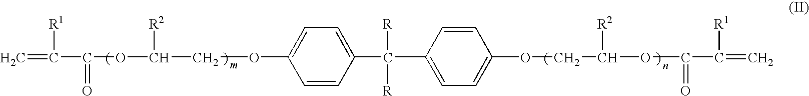

in which R¹ and R² represent, independently of one another, a hydrogen atom or a CH₃ group, R represents a hydrogen atom or a C₁-C₆ alkyl radical, the sum m+n being an integer in the range from 2 to 8.

The aromatic poly(meth)acrylic compounds of formula (II) that are preferred are polyalkoxylated di(meth)acrylates of bisphenols A and F, i.e. those in which R denotes H or CH₃. Among these, there may be mentioned, non-exhaustively, 2,2-bis[4-(acryloxy-ethoxy)-phenyl]propane, 2,2-bis[4-(methacryloxy-ethoxy)phenyl]-propane, 2,2-bis[4-(acryloxy-diethoxy)-phenyl]propane, 2,2-bis[4-(methacryloxy-diethoxy)phenyl]propane, 1,1-bis[4-(acryloxy-ethoxy)phenyl]methane, 1,1-bis[4-(methacryloxy-ethoxy)phenyl]methane, 1,1-bis[4-(acryloxy-diethoxy)phenyl]methane, 1,1-bis[4-(methacryloxy-diethoxy)phenyl]methane.

The preferred aromatic poly(meth)acrylate is tetraethoxylated bisphenol A dimethacrylate, or 2,2-bis[4-(methacryloxy-diethoxy)phenyl]propane, marketed by the company Akzo-Nobel under the name D121, and conforming to formula (III), i.e. the compound of formula (II) in which R¹ represents a —CH₃ group, R² represents H, R represents CH₃, with m and n equal to 2:

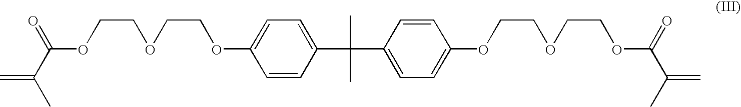

The polymerization of the polymerizable mixture according to the invention can be of radical, anionic, or cationic type or can be carried out by metathesis by ring opening in the presence of cyclo-olefins, techniques that are well known to a person skilled in the art. Where the polymerizable mixture according to the invention contains polymerizable monomers bearing ethylene groups, the initiation of the polymerization and the polymerization are generally carried out under irradiation. This may be a photopolymerization, optionally in the presence of a polymerization initiator, or irradiation by means of a beam of electrons (electron beam irradiation), a type of polymerization that does not require the presence of a polymerization initiator since the energy of the electron beam is sufficient to create the free radicals required for polymerization. The polymerizable mixture according to the invention can also be polymerized using a combination of these methods. Preferably, the thermosetting polymerizable composition of the invention comprises at least one polymerization initiator, preferably at least one photoinitiator. As the polymerizable mixture of the invention is polymerized at a relatively low temperature, it is preferable to use a method of photopolymerization with or without polymerization initiator, rather than another method.

According to a particularly preferred embodiment, the thermosetting polymerizable composition of the invention is polymerized by photopolymerization and comprises at least one photoinitiator, the latter preferably representing from 0.1% to 10% of the mass of the thermosetting polymerizable composition.

Among the photoinitiators that can be used for the purposes of the invention in the thermosetting polymerizable composition, there may be mentioned, without limitation, aromatic α-hydroxy-ketones, α-amino-ketones, benzophenones, acetophenones, benzyldimethylketals, monoacylphosphine oxides (MAPO), bisacylphosphine oxides (BAPO), tertiary amine/diketone mixtures, alkylbenzoyl ethers, benzoin ethers, phenyl glyoxylates, thioxanthones and cationic photoinitiators such as triaryl sulphonium salts and aryliodonium salts.

There may be mentioned in particular the photo-initiators marketed by the company Ciba Specialty Chemicals under the general designation IRGACURE®, in particular the photoinitiator IRGACURE® 184 (1-hydroxycyclohexyl-phenylketone), the photoinitiator IRGACURE® 500 which is a 50/50 by mass mixture of 1-hydroxycyclohexyl-phenylketone and benzophenone, the photoinitiator IRGACURE® 651 (2,2-dimethoxy-2-phenyl-acetophenone), the photoinitiator IRGACURE® 819 (bis(2,4,6-trimethylbenzoyl)-phenylphosphine oxide), the photoinitiator IRGACURE® 907 (2-methyl-1-[4-(methylthio)-phenyl]-2-morpholino-propan-1-one), the photoinitiator IRGACURE® 1700 (25/75 by mass mixture of bis(2,6-dimethoxybenzoyl)-2,4,4-trimethylpentyl-phosphine oxide and DAROCUR® 1173), the photoinitiators marketed by the company Ciba Specialty Chemicals under the general designation DAROCUR®, in particular the photoinitiator DAROCUR® 1173 (2-hydroxy-2-methyl-1-phenyl-propan-1-one), the photoinitiator DAROCUR® TPO (2,4,6-trimethylbenzoyl-diphenylphosphine oxide), the photoinitiator DAROCUR® 4265 (50/50 by mass mixture of DAROCUR® 1173 and DAROCUR® TPO), the photoinitiator marketed by the company Ciba Specialty Chemicals under the denomination CGI 1850, which is a 50/50 by mass mixture of IRGACURE® 184 and bis(2,6-dimethoxybenzoyl)-2,4,4-trimethylpentyl-phosphine oxide, the photoinitiators marketed by the company BASF under the general designation Lucirin®, in particular the photo-initiator Lucirin® TPO-L (2,4,6-trimethylbenzoylphenyl-ethyl phosphinate), bis(2,6-dimethoxy-benzoyl)-2,4,4-trimethylpentyl-phosphine oxide, benzophenone, 2,4,6-trimethylbenzophenone, 4-methylbenzophenone, 2,2-dimethoxy-2-phenyl-acetophenone, 2,2-diethoxy-acetophenone (DEAP, marketed by Upjohn), 4-(2-hydroxyethoxy)phenyl-(2-hydroxy-2-methylpropyl) ketone, 2-benzyl-2-N,N-dimethylamino-1-(4-morpholinophenyl)-butan-1-one.

The preferred photoinitiator is CGI 1850, conforming to formula (IV):

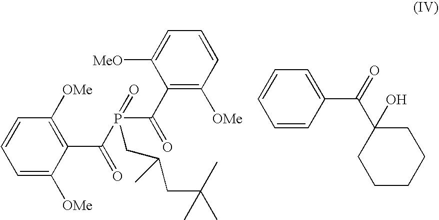

In general, the mass of the polymerization initiators represents from 0.1 to 10% of the mass of the thermosetting polymerizable composition according to the invention. The polymerization reaction is initiated using U an appropriate means, namely visible light, UV radiation, or any other means, the choice depending on the type of photoinitiator used.

The polymerization initiators can be used alone or mixed with hardness-modifying agents, for example photo-sensitizers, accelerators (catalysts) or polymerization inhibitors, in conventional proportions. Certain photo-initiators can also have photosensitization properties.

Non-limiting examples of photosensitizers and accelerators that can be used in the present invention are thioxanthones such as ITX (2- or 4-isopropyl-thioxanthone) or chlorothioxanthones such as CPTX (1-chloro-4-propoxythioxanthone), quinones such as camphorquinone, benzanthrones, Michler's ketone (4,4′-bis(dimethylamino)-benzophenone), fluorenone, triphenyl acetophenone, dimethyl-ethanolamine, methyldiethanolamine, triethanolamine, DMPT (N,N-dimethyl-para-toluidine), MHPT (N-[2-hydroxyethyl]-N-methyl-para-toluidine), ODAB (para-N,N-dimethylamino octyl benzoate), EDAB (para-N,N-dimethylamino-ethyl benzoate, marketed by Aceto Corporation under the name Quantacure® EPD), EDMA (2-ethyl-9,10-dimethoxyanthracene or mixtures thereof. In particular, a camphorquinone/EDAB mixture can be used.

Non-limiting examples of polymerization inhibitors (inhibitors of free radicals) that can be used in the present invention are the ammonium salt of N-nitroso-N-phenylhydroxylamine, the aluminium salt of tris[N-nitroso-N-phenylhydroxylamine, 4-methoxyphenol (MEHQ), hydroquinone and the substituted hydroquinones, pyrogallol, U phenothiazine, 4-ethyl-catechol, sterically hindered amines and mixtures thereof.

The thermosetting polymerizable composition according to the invention can also comprise a certain number of other additives used conventionally in polymerizable compositions for optical articles, in particular ophthalmic lenses, in conventional proportions. Examples of additives are, without limitation, colorants, stabilizers such as UV absorbers, antioxidants and anti-yellowing agents, perfumes, deodorants, mould-release agents, lubricants, adhesion promoters and coupling agents.

Among the UV absorbers (systems that filter UV radiation) that can be used for the purposes of the invention in the thermosetting polymerizable composition, there may be mentioned, without limitation, 4-aminobenzoic acid (PABA) and its salts, anthranilic acid and its salts, salicylic acid and its salts or its esters, in particular aryl hydroxybenzoates, 4-hydroxycinnamic acid and its salts, sulphonic derivatives of benzoxazoles, benzymidazoles and benzothiazoles and their salts, benzophenones, in particular the sulphonic derivatives of benzophenones and the 2-hydroxybenzophenones and their salts, the sulphonic derivatives of benzylidene camphor and their salts, derivatives of benzylidene camphor substituted with a quaternary ammonium group and their salts, the phthalylidene derivatives of camphorsulphonic acid and their salts, benzotriazoles, in particular the sulphonic derivatives of benzotriazole and their salts, oxalamides, oxanilides, and mixtures thereof.

Non-limiting examples of UV absorbers that can be used in the present invention are 2-(2-hydroxyphenyl)-2H-benzotriazole, PBSA (sodium salt of 2-phenyl-benzymidazole-5-sulphonic acid, marketed under the name PARSOL® HS by Givaudan-Roure), 4-tert-butyl-4′-methoxy-dibenzoylmethane (marketed under the name PARSOL® 1789 by Givaudan-Roure), 2-ethylhexyl p-methoxycinnamate or avobenzone (marketed under the name PARSOL® MCX by Givaudan-Roure), octyl p-methoxycinnamate, UVINUL® MS 40 (2-hydroxy-4-methoxybenzophenone-5-sulphonic acid, BASF), UVINUL® M 40 (2-hydroxy-4-methoxybenzophenone, BASF), octocrylene (2-ethylhexyl 2-cyano-3,3-diphenylacrylate), 2-ethylhexyl 4-dimethylaminobenzoate (octyl dimethyl-PABA), triethanolamine salicylate, octyl salicylate. It is also possible to use polymers having UV photoprotection properties, in particular the polymers comprising benzylidene camphor and/or benzotriazole groups, substituted with sulpho or quaternary ammonium groups. They can be used alone or mixed with other UV absorbers.

Anti-yellowing agents such as those described in patents U.S. Pat. No. 5,442,022, U.S. Pat. No. 5,445,828, U.S. Pat. No. 5,702,825, U.S. Pat. No. 5,741,831 and FR 2699541 can be used, without limitation, alone or mixed. The preferred anti-yellowing agent is 3-methyl-but-2-en-1-ol (M-BOL). In general, the mass of the anti-yellowing agents represents from 0.5 to 4% of the mass of the thermosetting polymerizable composition according to the invention.

Among the antioxidants that can be used for the purposes of the invention in the thermosetting polymerizable composition, there may be mentioned, without limitation, the sterically hindered phenolic antioxidants, IRGANOX® 245 DW (ethylene-bis(oxyethylene)bis-(3-(5-tert-butyl-4-hydroxy-m-tolyl)propionate) marketed by the company Ciba Specialty Chemicals.

The second material, used in the present invention to modify the mechanical and/or optical properties of the first material, comprises at least one polymer and preferably represents from 3% to 30% of the mass of the polymerizable mixture according to the invention. This second material is soluble in the thermosetting polymerizable composition defined above and is preferably a thermoplastic material.

According to a preferred first embodiment of the method of the present invention, the second polymeric material comprises at least one block copolymer, also called sequenced polymer.

The block copolymers, in particular diblocks and triblocks, suitable for the present invention are well known to a person skilled in the art. Preferably, the second material according to the invention comprises at least one triblock copolymer comprising at least one polystyrene block, at least one polybutadiene block and at least one poly(methyl methacrylate) block or poly(methyl acrylate) block. The particularly preferred triblock polymers are the polystyrene-block-polybutadiene-block-poly(methyl methacrylate) (PS-b-PB-b-PMMA) triblock copolymers, called SBM copolymers hereinafter.

The block copolymers that can be used within the framework of the invention are described in particular in patent applications WO 2005/073314 and WO 2005/014699. Reference should be made in particular to these documents for a detailed description of the PS, PB and PMMA portions of these block copolymers.

Finally, it is important for the production of a transparent moulding comprising a blend of polymers by the method of the invention that the poly(methyl methacrylate) (PMMA) block of the block polymer represents a relatively large fraction of the block copolymer. According to an advantageous variant of the invention, the PMMA block preferably represents from 50% to 80% by weight, more preferably from 52% to 70% by weight, of the weight-average molar mass of the polystyrene-block-polybutadiene-block-poly(methyl methacrylate) block copolymer.

Thus, for an SBM triblock copolymer having a weight-average molar mass comprised between 15 000 and 200 000 g/mol, the weight-average molar mass of the poly(methyl methacrylate) block is preferably between 10,000 and 100,000 g/mol.

Within the framework of the invention it is understood that the block copolymers used can be a mixture of triblock copolymers and of diblock copolymers of the polystyrene-block-polybutadiene type. These copolymers are described in particular in patent application WO 2005/073314.

According to a preferred second embodiment, the second material comprises at least one polysulphone (PSU). The polysulphones that can be used in the present invention can be any polymer containing sulphone groups in its main chain, such as poly(arylene sulphone), for example poly(phenylene sulphone), poly(ether sulphones) or poly(ether arylsulphones). These polysulphones must of course be soluble in the thermosetting polymerizable compositions of the invention. The polysulphones according to the invention typically have a weight-average molar mass ranging from 20 000 to 60 000 g/mol, preferably from 30 000 to 40 000 g/mol. Preferably, the polysulphones are poly(ether sulphones or poly(ether arylsulphones). The basic unit of these two categories of polysulphones conforms to the general formula (VI):

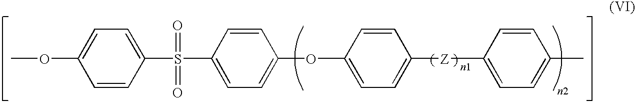

in which n1 is equal to 0 or 1, n2 denotes an integer in the range from 0 to 10, Z denotes O, S, Se, NH, C═O, SO, SO₂, SeO₂, CH₂, —CH═CH— or —C(R)₂— with R representing a hydrogen atom or a C₁-C₆ alkyl radical. When n2 is equal to 0, the compound of formula (VI) is a poly(ether sulphone). When n2 is not zero, the compound of formula (VI) is a poly(ether arylsulphone). A preferred class of polysulphones comprises the poly(ether arylsulphones) having repeating units according to formula (VII):

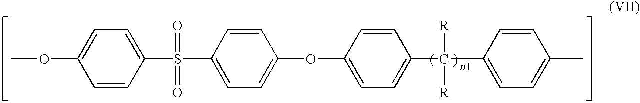

in which n1 is equal to 0 or 1, R represents a hydrogen atom or a C₁-C₆ alkyl radical. Among the compounds of formula (VII), there may be mentioned 4,4′-dihydroxybiphenyl polysulphone (n1=0), bisphenol A polysulphone (n1=1, R═CH₃) and bisphenol F polysulphone (n1=1, R═H). The polysulphone that is preferred for the invention is bisphenol A polysulphone, whose basic units conform to formula (VIII), and which is marketed in particular by Aldrich under reference 42,830-2:

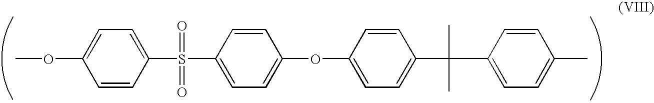

As pointed out previously, the second polymeric material is preferably a thermoplastic polymeric material. Any thermoplastic polymer can be used in the method according to the invention, provided that it is initially soluble in the thermosetting polymerizable composition employed. In addition to the polysulphones and the block copolymers previously defined, the second material can be selected, in a non-limiting manner, from the following thermoplastic (co)polymers: the aliphatic poly(meth)acrylates, such as poly(meth)methyl acrylate, polyethylene, polypropylene, polystyrene, poly(phenylene sulphide), poly(arylene oxides), the polyimides, the polyesters, the polycarbonates such as bisphenol A polycarbonate, poly(vinyl chloride), the polyamides such as the nylons, the thermoplastic polyurethanes and mixtures thereof. In addition to the aliphatic or aromatic poly(meth)acrylates previously defined, the thermosetting polymerizable composition of the invention can comprise precursors of polyimides, precursors of polycyclopentadienes, precursors of epoxy resins, polycarbonates such as bis(allyl carbonates) and mixtures thereof.

A combination that is particularly preferred among the latter uses polymethyl(meth)acrylate as second polymeric material and a thermosetting polymerizable composition comprising an aliphatic or aromatic poly(meth)acrylate.

The method of the invention comprises at least six stages. The first consists of preparing a polymerizable mixture by solubilizing the second polymeric material in the thermosetting polymerizable composition. The second polymeric material is preferably used in the form of powder or granules. It is generally added progressively and with stirring to the thermosetting polymerizable composition. If the dispersion obtained is not homogeneous at ambient temperature, it can be heated with stirring in a thermostatically-controlled oil bath until the second material has dissolved completely. By ambient temperature is meant in the present invention a temperature between 15 and 25° C. This dissolution stage can take several weeks at a temperature of the order of 80° C. The polymerizable mixture obtained, generally transparent and viscous, can be filtered, optionally while hot, then degassed with stirring, optionally while hot, before it is used in the second, cast moulding stage. The latter consists of filling a mould with the polymerizable mixture thus obtained. Optionally, said polymerizable mixture can be preheated, just like the mould. Generally, a temperature of the order of 90° C. is perfectly suitable. The polymerizable liquid mixture can for example be cast in an assembly made up of two mould parts made of mineral glass held together by an adhesive tape at the periphery. The third stage consists of cooling the polymerizable mixture filling the mould to a temperature T less than or equal to 0° C., by placing it for example in a freezer, so as to increase its viscosity. At this temperature T, the polymerizable mixture is liquid. The assembly can be left overnight in the freezer, for example to make sure that the temperature of the polymerizable mixture is uniform before polymerization. It is not, however, necessary for the temperature of the freezer to be equal to said temperature T less than or equal to 0° C. The fourth stage consists of initiating, preferably by photoinitiation, the polymerization of said polymerizable mixture when it is at a temperature T′ less than or equal to 0° C. The fifth stage consists of continuing the polymerization of said polymerizable mixture, preferably by photopolymerization, until a hardened blend of polymers is obtained. It can, for example, be carried out by removing the mould from the freezer and putting it under a UV lamp, while the polymerizable mixture that it contains is at a temperature T′ less than or equal to 0° C. Finally, the moulding comprising said blend is removed from the mould and recovered.

The transparent mouldings obtained according to the method of the invention are preferably optical articles, i.e. organic glasses. They are intended, generally but not exclusively, for use as optical articles, preferably as ophthalmic lenses. They can offer the advantage of combining the advantageous properties of each of the two materials, in particular the resistance to solvents of the first thermoset material and a good impact strength provided by the second polymeric material if it is a thermoplastic material.

To improve other properties of said optical articles, for example ophthalmic lenses, the substrate of which is of organic glass, such as for example abrasion and scratch resistance, anti-reflective character and smear-resistance, it is possible to form one or more functional coatings on at least one of their principal surfaces. A major drawback of organic glasses, which are less hard than mineral glasses, is their low resistance to scratching. It is thus entirely conventional to form successively, on a principal surface of the substrate, a first coating, called primary anti-impact coating, the purpose of which is to increase the impact strength of the article and also the adhesion of subsequent coatings to the substrate then, on this primary anti-impact coating, a hard coating, generally called anti-abrasion or anti-scratch coating, the purpose of which is to improve the ability of the surface of the optical article to withstand damage due to mechanical stresses. The anti-abrasion coating will be covered with an anti-reflective coating, which in its turn will be covered with an anti-smear coating, whose role is to modify the interfacial tension between the anti-reflective layer and water or grease (in order to reduce their adherence), but also to block the interstices so as to prevent grease from infiltrating and remaining.

The following examples illustrate the method, the polymerizable mixtures and the optical articles according to the invention, without being limiting.

### EXAMPLES

In the two examples given below, the thermosetting polymerizable composition is a photopolymerizable acrylic formulation, designated “formulation A”, comprising:

98 mass-% of a dimethacrylate of formula (III),

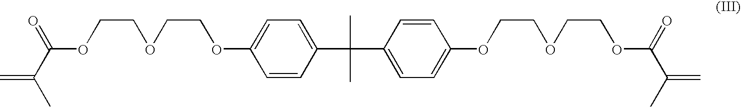

1.8 mass-% of 3-methyl-but-2-en-1-ol (M-BOL, anti-yellowing agent),

0.2 mass-% of CGI 1850 [photoinitiator of formula (IV)], the percentages being expressed relative to the total mass of the thermosetting polymerizable composition.

### Example 1

### Preparation of a Very Little Diffusing Blend of Polymers of the Formulation A/SBM Block Copolymer Type Containing about 10 Mass-% of Thermoplastic Phase

The “second polymeric material” used in this example is a thermoplastic block copolymer of the SBM type. The block copolymer used in this example is thus a PS-b-PB-b-PMMA with weight-average molar mass of 41 900 g/mol having a fraction by mass of the PMMA block greater than 50%.

Procedure

Stage 1: Preparation of the Polymerizable Mixture
Weighing of 549.37 g of formulation A into a glass bottle.
Gradual addition, with stirring, of 61.55 g of powdered SBM copolymer as described to formulation A, with stirring, and dispersion at ambient temperature with stirring.
Stage of dissolution of the SBM copolymer in formulation A by heating with a thermostatically-controlled oil bath (80° C.), with stirring, for 7 days.

The polymerizable mixture obtained is transparent and viscous (viscosity: about 10 Pa·s at ambient temperature).

Stage 2: Preparation of a 2 mm-Thick Biplanar Lens
Heating of the polymerizable mixture to 90° C. then filtration at 20 microns.
Degassing of the filtered polymerizable mixture at 90° C. for 2 hours, with stirring.
Removal of about 30 mL of polymerizable mixture in a syringe that has been preheated to 90° C.
Injection of about 30 mL of polymerizable mixture in an assembly constituted by two mould parts of mineral glass held together by adhesive tape at the periphery, preheated to 90° C.
Placing of the assembly in a freezer. The assembly is left in the freezer overnight at −10° C. (the temperature is measured with a thermocouple immersed in the polymerizable mixture).
Removal from the freezer.
Polymerization under ultraviolet (IST oven, Fe-doped lamp, 36 mJ/cm²) for 4 minutes. The temperature of the polymerizable mixture at the start of polymerization is equal to 0° C.
Removal of the glass from the assembly.

### Comparative Example C1

Identical to Example 1, except that the assembly is not put in a freezer after the cast moulding stage but is polymerized directly under ultraviolet starting at 27° C. (the temperature is measured with a thermocouple immersed in the polymerizable mixture)

### Comparative Example C2

Identical to Example 1, except that the assembly is not put in a freezer after the cast moulding stage but is polymerized directly under ultraviolet starting at 50° C. (the temperature is measured with a thermocouple immersed in the polymerizable mixture)

These examples illustrate the influence of the temperature of the polymerizable mixture, measured at the start of polymerization, on the nano-structuring of the blend of polymers. The demixing of a phase formed by the poly(methyl methacrylate) block is prevented in Example 1 (T=0° C.), which makes it possible to maintain nano-structuring and obtain a material that is macroscopically transparent and non-(or very little) diffusing. The materials of Examples C1 (27° C.) and C2 (50° C.) are more diffusing than that of Example 1. In particular, the sample of Example C2 is very diffusing. The transparency of the blend can therefore be optimized by increasing the viscosity of the polymerizable mixture.

### Example 2

### Preparation of a Very Little Diffusing Blend of the Formulation A/Polysulphone Type Containing about 5 Mass-% of Thermoplastic Phase

The “second material” used in this example is a thermoplastic polysulphone whose basic unit conforms to formula (VIII), shown below. This polysulphone is marketed by Aldrich under the reference 42,830-2 (molar mass: 35000 g/mol). The advantage of this thermoplastic polymer is its high refractive index (n=1.63 to 1.67) and good impact strength and heat resistance.

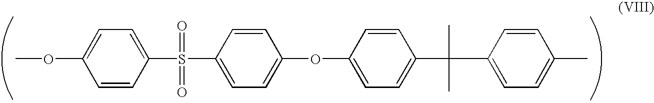

Procedure

Stage 1: Preparation of the Polymerizable Mixture
Weighing of 357.03 g of formulation A into a glass bottle.
Addition of 20 g of granules of the polysulphone described above to formulation A and dispersion of the granules at ambient temperature.
   Dissolution stage: solubilization, in a thermostatically-controlled oil bath (80° C.) and with stirring, of the polysulphone for 3 weeks.

The polymerizable mixture obtained is transparent and viscous (viscosity: plainly above 4 Pa·s at ambient temperature).

Stage 2: Preparation of a 2 mm-Thick Biplanar Lens
Heating of the polymerizable mixture to 90° C. then filtration at 20 microns.
Degassing of the filtered polymerizable mixture at 90° C. for 2 hours, with stirring.
Removal of about 30 mL of polymerizable mixture in a syringe preheated to 90° C.
Injection of about 30 mL of polymerizable mixture into an assembly constituted by two mould parts of mineral glass held together with adhesive tape at the periphery, preheated to 90° C.
Placing of the assembly in a freezer. The assembly is left in the freezer overnight at −10° C. (the temperature is measured with a thermocouple immersed in the polymerizable mixture).
Removal from the freezer and polymerization under ultraviolet (IST oven, Fe-doped lamp, 36 mW/cm²) for 10 minutes. The temperature of the polymerizable mixture at the start of polymerization is equal to −10° C.
Removal of the glass from the assembly.

### Comparative Example C3

Identical to Example 2, except that the assembly is not put in a freezer after the cast moulding stage but is polymerized directly under ultraviolet starting at 50° C. (the temperature is measured with a thermocouple immersed in the polymerizable mixture).

These examples illustrate the influence of the temperature of the polymerizable mixture measured at the start of polymerization on the final structure of the blend. The demixing of a phase formed by the thermoplastic polysulphone during the polymerization of the thermosetting phase is avoided in Example 2 (T=−10° C.), permitting a nano-structuring and the production of a material that is macroscopically transparent and non- (or very little) diffusing.

However, the thermoplastic, initially solubilized in formulation A, does not remain dispersed homogeneously in the thermoset phase when the temperature at the start of polymerization is 50° C. The blend of Example C3 (50° C.) is diffusing, the thermoplastic being expelled from the thermoset network during the polymerization.

1. Method of preparing a transparent moulding comprising a blend of a first thermoset polymeric material forming the matrix of said moulding, and of a second polymeric material dispersed within said first material, said method comprising at least the following stages:
i) preparation of a liquid polymerizable mixture by dissolution of said second polymeric material in a thermosetting polymerizable composition that is a precursor of said first thermoset polymeric material,
ii) filling of a mould with the liquid polymerizable mixture obtained in stage i),
iii) cooling of the liquid polymerizable mixture in the mould to a temperature T less than or equal to 0° C.,
iv) initiation of the polymerization of said cooled liquid polymerizable liquid mixture at a temperature T′ less than or equal to 0° C.,
v) continuation of the polymerization of said liquid polymerizable mixture until a hardened blend of polymers is obtained, and
vi) removal of the moulding formed from said blend of polymers from the mould.

2. Method of preparing a transparent moulding according to claim 1, characterized in that the temperatures T and T′ are, independently, between −15° C. and 0° C.

3. Method of preparing a transparent moulding according to claim 1, characterized in that the thermosetting polymerizable composition represents from 70 to 97% of the mass of the polymerizable mixture and in that the second polymeric material represents from 3 to 30% by weight of the polymerizable liquid mixture.

4. Method of preparing a transparent moulding according to claim 1, characterized in that the thermosetting polymerizable composition comprises at least one material selected from a polymerizable monomer, a polymerizable oligomer and a polymerizable prepolymer.

5. Method of preparing a transparent moulding according to claim 4, characterized in that the thermosetting polymerizable composition comprises at least one monomer selected from a polymerizable aliphatic polymethacrylate monomer, a polymerizable aromatic polymethacrylate monomer, a polymerizable aliphatic polyacrylate monomer, and a polymerizable aromatic polyacrylate monomer.

6. Method of preparing a transparent moulding according to claim 5, characterized in that said monomer is selected from the polyalkoxylated aromatic dimethacrylates and the polyalkoxylated aromatic diacrylates.

7. Method of preparing a transparent moulding according to claim 1, characterized in that the thermosetting polymerizable composition comprises at least one monomer conforming to formula (I): 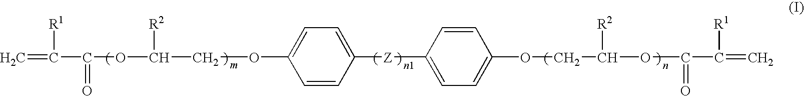
in which:
R¹ represents a hydrogen atom or a C₁-C₆ alkyl radical,
R² represents a hydrogen atom or a group selected from the C₁-C₆ alkyl radicals and 2-hydroxyethyl,
n1 is equal to 0 or 1,
Z represents a group selected from O, S, Se, NH, C═O, SO, SO₂, SeO₂, CH₂, —CH═CH— and —C(R)₂— where R represents a hydrogen atom or a C₁-C₆ alkyl radical, and
The sum m+n represents an integer between 1 and 10.

8. Method of preparing a transparent moulding according to claim 7, characterized in that the thermosetting polymerizable composition comprises at least one monomer conforming to formula (II): 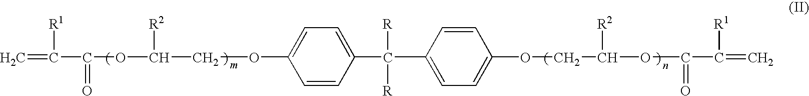
in which R¹ and R² each represent, independently of one another, a hydrogen atom or a CH₃ group, R represents a hydrogen atom or a C₁-C₆ alkyl radical, and the sum m+n represents an integer between 2 and 8.

9. Method of preparing a transparent moulding according to claim 8, characterized in that said monomer conforms to formula (III):

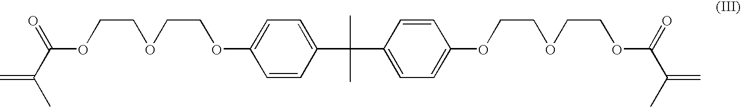

10. Method of preparing a transparent moulding according to claim 1, characterized in that the thermosetting polymerizable composition further comprises at least one polymerization initiator, preferably at least one photo-initiator, the mass of the polymerization initiator or initiators representing from 0.1 to 10% of the mass of the thermosetting polymerizable composition.

11. Method of preparing a transparent moulding according to claim 1, characterized in that said second polymeric material is a thermoplastic polymeric material.

12. Method of preparing of a transparent moulding according to claim 1, characterized in that the second polymeric material comprises at least one polysulphone having repeating units according to formula (VI): 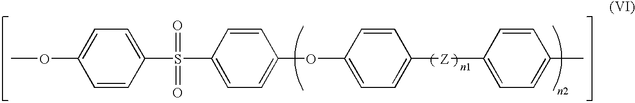
in which n1 is equal to 0 or 1, n2 represents an integer between 0 and 10, and Z represents a group selected from O, S, Se, NH, C═O, SO, SO₂, SeO₂, CH₂, —CH═CH— and —C(R)₂— where R represents a hydrogen atom or a C₁-C₆ alkyl radical.

13. Method of preparing a transparent moulding according to claim 12, characterized in that said polysulphone is a polysulphone having repeating units according to formula (VII): 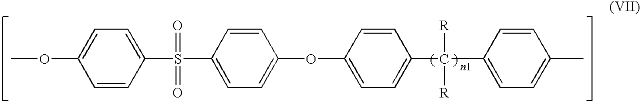
in which n1 is equal to 0 or 1 and R represents a hydrogen atom or a C₁-C₆ alkyl radical; preferably a polysulphone having repeating units according to formula (VIII):

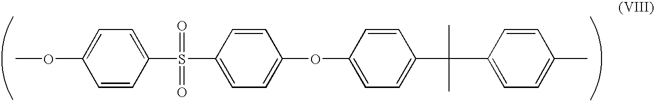

14. Method of preparing a transparent moulding according to claim 12, characterized in that said polysulphone has a weight-average molar mass between 20000 and 60000 g/mol, preferably between 30000 and 40000 g/mol.

15. Method of preparing a transparent moulding according to claim 1, characterized in that the second polymeric material comprises at least one block copolymer selected from diblock copolymers, triblock copolymers and mixtures thereof, preferably from triblock copolymers.

16. Method of preparing a transparent moulding according to claim 1, characterized in that the second polymeric material comprises at least one block copolymer having at least one block compatible with the thermosetting polymerizable composition allowing the dispersion of said block copolymer in said thermosetting polymerizable composition.

17. Method of preparing a transparent moulding according to claim 15, characterized in that the block copolymer comprises at least one poly(alkyl methacrylate) block or at least one poly(alkyl acrylate) block.

18. Method of preparing a transparent moulding according to claim 17, characterized in that said block copolymer has in addition at least one polystyrene block and at least one polybutadiene block.

19. Method of preparing a transparent moulding according to claim 15, characterized in that said block copolymer is a polystyrene-block-polybutadiene-block-poly(methyl methacrylate) (PS-b-PB-b-PMMA) block copolymer.

20. Method of preparing a transparent moulding according to claim 19, characterized in that the PMMA block represents from 50% to 80% by weight, preferably from 52% to 70% by weight of the weight-average molar mass of the polystyrene-block-polybutadiene-block-poly(methyl methacrylate) block copolymer.

21. Method of preparing a transparent moulding according to claim 15, characterized in that the weight-average molar mass of said poly(methyl methacrylate) block is comprised between 10 000 and 100 000 g/mol.

22. Method of preparing a transparent moulding according to claim 1, characterized in that the polymerizable mixture is polymerized by photopolymerization.

23. Method of preparing a transparent moulding according to claim 1, characterized in that said transparent moulding is an optical article, preferably an ophthalmic lens.

24. Transparent moulding obtainable by a method according to claim 1, said moulding comprising a blend of polymers, at least one of which is a thermosetting polymer.
